(19) United States
(12) Patent Application Publication
(10) Pub. No.: US 2023/0312372 A1
(43) Pub. Date: Oct. 5, 2023

(54) WATER TREATMENT SYSTEM, INFORMATION PROCESSING DEVICE, INFORMATION PROCESSING METHOD, AND PROGRAM

(71) Applicant: ORGANO CORPORATION, Tokyo (JP)

(72) Inventors: Masaharu KAMATA, Tokyo (JP); Daisaku YANO, Tokyo (JP); Akihiro MOTOMIYA, Tokyo (JP); Fumio SUDO, Tokyo (JP)

(73) Assignee: ORGANO CORPORATION, Tokyo (JP)

(21) Appl. No.: 18/024,844

(22) PCT Filed: Aug. 20, 2021
(86) PCT No.: PCT/JP2021/030530

§ 371 Date: Mar. 6, 2023

(30) Foreign Application Priority Data
Sep. 9, 2020 (JP) 2020-151402

(51) Int. Cl. C02F 1/00

(52) U.S. Cl. CPC C02F 1/008; C02F 2209/20; C02F 2209/006; C02F 2103/04

(57) ABSTRACT

Water treatment apparatuses for removing impurities from supplied water and an information processing device are provided. The information processing device, based on the removal rates for removing impurities in the water treatment apparatuses, calculates a predicted value of the concentration of impurities contained in the water supplied from the water to be treatment apparatuses when water currently being supplied is treated by the water treatment apparatuses.

### TECHNICAL FIELD

The present invention relates to a water treatment system, an information processing device, an information processing method, and a program.

### BACKGROUND OF ART

In a water treatment system, the concentration of impurities in water supplied to a point of use is measured using a dedicated concentration meter. For example, an ion detecting apparatus detects the ion concentration of water that has passed through an ion exchange resin apparatus that removes ionic substances in ultrapure water. A technique of bypassing the ion exchange resin device based on the result detected by the ion detecting apparatus is then considered (e.g., see Patent Document 1).

### PRIOR ART DOCUMENTS

### Patent Documents

[Patent Document 1] JP-6-134457

### SUMMARY OF THE INVENTION

### Problem to be Solved by the Invention

In the technique described above, when the concentration measured by the concentration meter exceeds a reference value, water having a concentration exceeding the reference value has already been supplied to the point of use. Therefore, when the concentration measured by the concentration meter exceeds a predetermined value, there is the problem that water having a concentration exceeding the predetermined value has been supplied to the point of use. Therefore, it is necessary to comprehend the water quality of the supplied water in advance.

An object of the present invention is to provide a water treatment system, an information processing device, an information processing method and a program capable of comprehending the water quality of the water to be supplied in advance.

### Means for Solving the Problem

The present invention is a water treatment system, comprising:
a water treatment apparatus that removes impurities from water that is supplied, and
an information processing device, wherein
the information processing device comprises:
a concentration calculation unit that, based on a removal rate for removing impurities in the water treatment apparatus, calculates a predicted value of a concentration of impurities contained in water to be supplied from the water treatment apparatus when water currently being supplied is treated by the water treatment apparatus.

Further, the present invention is an information processing device, comprising: a concentration calculation unit that, based on a removal rate for removing impurities in a water treatment apparatus that removes the impurities from the supplied water, calculates a predicted value of a concentration of impurities contained in water to be supplied from the water treatment apparatus when water currently being supplied is treated by the water treatment apparatus.

Further, the present invention is an information processing method, comprising:
a process for, based on a removal rate for removing impurities in a water treatment apparatus that removes the impurities from supplied water,
calculating a predicted value of a concentration of impurities contained in water to be supplied from the water treatment apparatus when water currently being supplied is treated by the water treatment apparatus.

Further, the present invention is a program to make a computer execute procedures, the procedures comprising:
a procedure for, based on a removal rate for removing impurities in a water treatment apparatus that removes the impurities from supplied water, calculating a predicted value of a concentration of impurities contained in water to be supplied from the water treatment apparatus when water currently being supplied is treated by the water treatment apparatus.

### Advantageous Effects of the Invention

In the present invention, the water quality of the water to be supplied can be comprehended in advance.

### BRIEF DESCRIPTION OF THE DRAWINGS

FIG. 1 is a diagram showing a first embodiment of the water treatment system of the present invention.

FIG. 2 is a diagram showing an example of the internal configuration of the information processing device shown in FIG. 1.

FIG. 3 is a table illustrating exemplary predicted TOC values in the water treatment apparatus calculated by the concentration calculation unit shown in FIG. 2.

FIG. 4 is a diagram showing an example of a specific configuration of a water treatment system in the present embodiment.

FIG. 5 is a diagram showing a second embodiment of the water treatment system of the present invention.

FIG. 6 is a diagram showing an example of the internal configuration of the information processing device shown in FIG. 5.

FIG. 7 is a table showing an example of information showing records of the past use stored in the database shown in FIG. 6.

### DESCRIPTION OF EMBODIMENTS

Embodiments of the present invention will be described below with reference to the accompanying drawings.

### First Embodiment

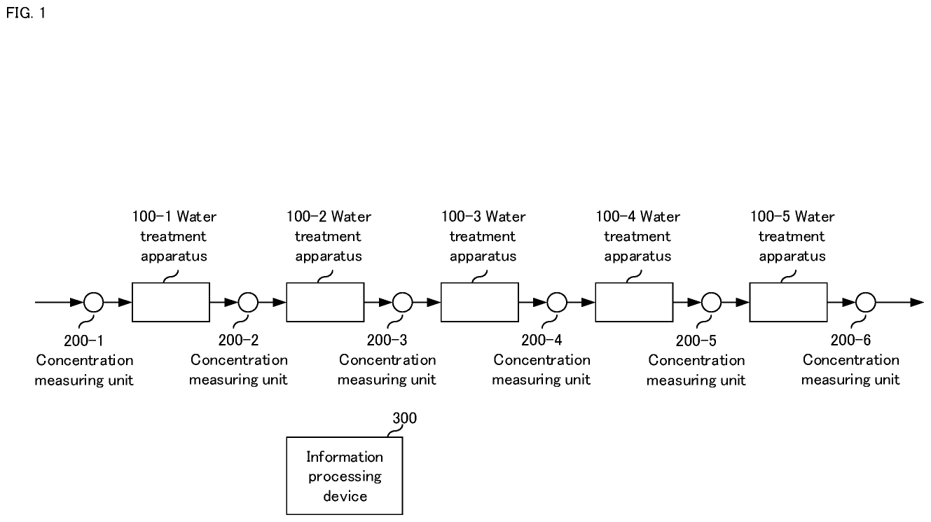

FIG. 1 is a diagram showing a first embodiment of the water treatment system of the present invention. As shown in FIG. 1, the water treatment system according to this embodiment includes a plurality of water treatment apparatuses 100-1 to 100-5, a plurality of concentration measuring units 200-1 to 200-6, and information processing device 300. In FIG. 1, a case in which the number of water treatment apparatus 100-1 to 100-5 is five is taken as an example. Further, in FIG. 1, a case in which the number of concentration measuring units 200-1 to 200-6 is six is taken as an example. The number of each of the water treatment apparatuses and the concentration measurement units in the water treatment system of the present invention is not limited.

Water treatment apparatuses 100-1 to 100-5 are connected (arranged) in a series. Water treatment apparatuses 100-1 to 100-5 remove impurities from the water supplied to each over a predetermined period of time. This predetermined time is, for example, the residence time from the time water flows into each of water treatment apparatuses 100-1 to 100-5 and the water is subjected to a predetermined treatment to the time, the water that has been treated is discharged to the outside. Also, this predetermined time is approximately the time determined for each water treatment apparatus 100-1 to 100-5. For example, the residence time in water treatment apparatus 100-1 is about 3 hours, the residence time in water treatment apparatus 100-2 is about 2 hours, and the residence time of water treatment apparatuses 100-3 to 100-5 is about 1 hour. The embodiment shown in FIG. 1 illustrates an example in which water treatment apparatuses 100-1 to 100-5 are connected in a series. For example, even if water treatment apparatuses 100-1 to 100-5 are connected in parallel, it will be sufficient if the removal rates described below can be calculated.

Concentration measuring unit 200-1 measures the concentration of impurities contained in the water supplied to water treatment apparatus 100-1, that is, in the water at the inlet side of water treatment apparatus 100-1. Each of concentration measuring units 200-2 to 200-5 measures the concentration of impurities contained in the water supplied from a respective water treatment apparatus of water treatment apparatuses 100-1 to 100-4, that is, in the water at the outlet side of each of water treatment apparatuses 100-1 to 100-4 (in other words, in the water at the inlet side of a respective water treatment apparatus of water treatment apparatuses 100-2 to 100-5). Concentration measuring unit 200-6 measures the concentration of impurities contained in the water supplied from water treatment apparatus 100-5, that is, in the water at the outlet side of water treatment apparatus 100-5. At this time, each of concentration measuring units 200-1 to 200-6 may measure at a time interval shorter than the predetermined time needed for each of water treatment apparatuses 100-1 to 100-5 to remove impurities. For example, when each of water treatment apparatuses 100-1 to 100-5 processes water over a respective residence time as described above, the concentrations of impurities contained in the water supplied to each of water treatment apparatuses 100-1 to 100-5 are measured with concentration measuring unit 200-1 measuring the concentration of impurities contained in the water supplied to water treatment apparatus 100-1 at an interval shorter than three hours, concentration measuring unit 200-2 measuring the concentration of impurities at an interval shorter than two hours, and each of concentration measuring units 200-3 to 200-6 measuring impurities at intervals shorter than one hour. The concentrations of impurities measured by concentration measuring units 200-1 to 200-6 are the concentrations of TOC (Total Organic Carbon) and urea contained in the water. The reason why concentration measuring units 200-1 to 200-6 are provided for each of water treatment apparatuses 100-1 to 100-5 is to calculate the removal rate of impurities in each of water treatment apparatuses 100-1 to 100-5.

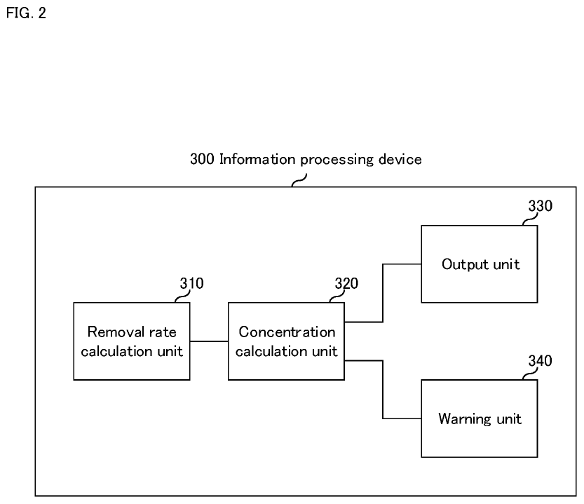

Information processing device 300 acquires concentration information indicating the concentrations measured by concentration measuring units 200-1 to 200-6. FIG. 2 is a diagram showing an example of the internal configuration of the information processing device 300 shown in FIG. 1. As illustrated in FIG. 2, information processing device 300 illustrated in FIG. 1 includes removal rate calculation unit 310, concentration calculation unit 320, output unit 330, and warning unit 340. Of the components of information processing device 300 shown in FIG. 1, FIG. 2 shows only the main components relating to the present embodiment.

Removal rate calculation unit 310 calculates the removal rate for removing impurities in each of water processing apparatuses 100-1 to 100-5. Removal rate calculation unit 310 acquires concentration information indicating the concentration measured by concentration measuring units 200-1 to 200-6. Removal rate calculation unit 310 calculates the removal rates of each of water treatment apparatuses 100-1 to 100-5 based on the concentrations indicated by the acquired concentration information. Specifically, removal rate calculation unit 310 calculates the removal rates of each of water treatment apparatuses 100-1 to 100-5 based on the concentration of impurities contained in the water supplied to each of water treatment apparatuses 100-1 to 100-5 and the concentration of impurities contained in the water supplied from each of water treatment apparatuses 100-1 to 100-5 measured by concentration measuring units 200-1 to 200-6. The calculation formula of this removal rate is:

(removal rate=((impurity concentration on the inlet side of the water treatment apparatus)−(impurity concentration on the outlet side of the water treatment apparatus))/impurity concentration on the inlet side of the water treatment apparatus).

At this time, it is preferable that removal rate calculation unit 310 calculates the removal rates at the time intervals at which the concentration measuring units 200-1 to 200-6 measure the concentration. The removal rates calculated by removal rate calculation unit 310 are stored in a storage unit such as a storage unit (e.g., a storage medium such as a memory) provided in information processing device 300 or an external storage device capable of reading information from information processing device 300. By storing the removal rates calculated by removal rate calculation unit 310 in such a unit or device, it is possible to transmit a warning when the calculated removal rates decrease significantly (deteriorate) from the removal rates calculated in the past (previously). Further, by storing the removal rates calculated by removal rate calculation unit 310 in such a unit or device, the remaining life of the water treatment apparatuses can be predicted. Further, by storing the removal rates calculated by removal rate calculation unit 310 in such a unit or device, the removal rates for a predetermined time (e.g., one minute before the current time) can be used for calculations in concentration calculation unit 320.

Based on the removal rates of each of water treatment apparatuses 100-1 to 100-5 calculated by removal rate calculation unit 310 a predetermined time earlier, concentration calculation unit 320 calculates the concentration of impurities contained in the water supplied from the water treatment apparatus that is connected the furthest downstream of water treatment apparatuses 100-1 to 100-5 (i.e., the water treatment system composed of water treatment apparatuses 100-1 to 100-5). In the connection configuration shown in FIG. 1, the water treatment apparatus that is connected furthest downstream is water treatment apparatus 100-5. Concentration calculation unit 320 calculates a predicted value of the concentration of impurities contained in the water supplied from the water treatment apparatus arranged the most downstream based on the concentration of impurities contained in the water flowing into the water treatment apparatus connected the most upstream and the removal rates of water treatment apparatuses 100-1 to 100-5 calculated by removal rate calculation unit 310 a predetermined time earlier (e.g., the past time point closest to the present time point. When the removal rate is calculated at one minute intervals, this time is one minute earlier). To describe more specifically, concentration calculation unit 320 calculates a predicted value of the concentration of TOC in the water supplied from each of water treatment apparatuses 100-1 to 100-5 based on the concentration of TOC contained in the water flowing into the water treatment apparatus disposed the most upstream and the removal rates of water treatment apparatuses 100-1 to 100-5 calculated by removal rate calculation unit 310 a predetermined time earlier (for example, one minute earlier). When calculating the concentration, concentration calculation unit 320 may use a removal rate set in advance for each of water treatment apparatuses 100-1 to 100-5 in addition to the removal rate calculated by removal rate calculation unit 310.

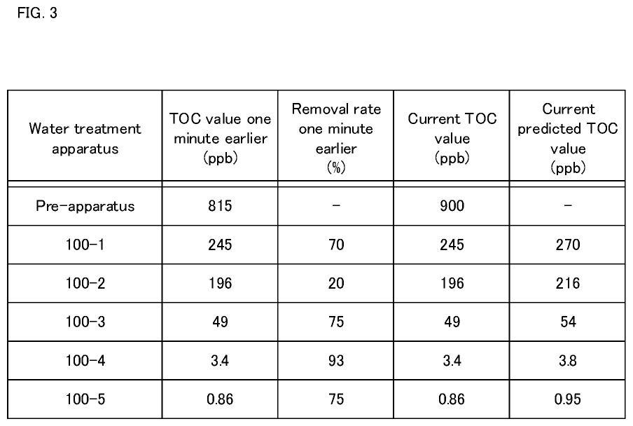

FIG. 3 is a diagram illustrating an example of predicted TOC values (predicted values of concentrations of TOC) in water treatment apparatuses 100-1 to 100-5 calculated by concentration calculation unit 320 shown in FIG. 2. Here, at upstream (preceding) water treatment apparatus 100-1, a water tank is disposed in which water to be treated is stored. The water to be treated is supplied to water treatment apparatus 100-1 from the water tank in which the water to be treated is stored.

The removal rates one minute earlier are the values of the removal rates of each of water treatment apparatuses 100-1 to 100-5 calculated by removal rate calculation unit 310 based on the concentrations measured by concentration measuring units 200-1 to 200-6 one minute earlier. First, when TOC contained in the water supplied from the apparatus preceding water treatment apparatus 100-1 is 900 (ppb) and the removal rate of water treatment apparatus 100-1 one minute earlier was 70 (%), concentration calculation unit 320 calculates the predicted TOC of water supplied from water treatment device 100-1 as:

900 (TOC value)×(1-0.7 (removal rate one minute earlier))=270

Subsequently, concentration calculation unit 320 calculates the predicted TOC of water supplied from water treatment apparatus 100-2 as:

270 (TOC predicted value)×(1−0.2 (removal rate one minute earlier))=216

Subsequently, concentration calculation unit 320 calculates the predicted TOC of water supplied from water treatment apparatus 100-3 as:

216 (TOC predicted value)×(1−0.75 (removal rate one minute earlier))=54

Subsequently, concentration calculation unit 320 calculates the predicted TOC of water supplied from water treatment apparatus 100-4 as:

54 (TOC predicted value)×(1−0.93 (removal rate one minute earlier))=3.8

Subsequently, concentration calculation unit 320 calculates the predicted TOC of water supplied from water treatment apparatus 100-5 as:

3.8 (TOC predicted value)×(1−0.75 (removal rate one minute earlier))=0.95

In this way, concentration calculation unit 320 calculates the concentration of TOC (impurities) contained in the water supplied from water treatment apparatus 100-5 connected the furthest downstream as the predicted TOC value.

Note that TOC includes urea. In a general water treatment apparatus, the removal rate of urea is markedly different (lower) than the removal rate of other impurities such as organic carbon. Therefore, the calculation of the removal rate of urea may be performed separately from the calculation of the removal rate of TOC. In such calculations, the removal rate of TOC, the removal rate of urea, and the removal rate of TOC excluding urea fraction need to be considered. As an observed empirical measure, 20% of the urea concentration may be detected as the TOC. In this way, rather than calculating the removal rate by simply using the value of the TOC on the inlet side of the water treatment apparatus and the value of TOC on the outlet side, a more accurate value of the TOC removal rate can be obtained by calculating the removal rate of the urea component and the removal rate of the other components. In other words, it is preferable to calculate the removal rate using a value obtained by subtracting the urea component from the value of the TOC on the inlet side of the water treatment apparatus.

Output unit 330 outputs concentration information indicating the concentration calculated by concentration calculation unit 320. Output unit 330 may display the concentration information indicating the concentration calculated by concentration calculation unit 320. Further, output unit 330 may transmit the concentration information indicating the concentration calculated by concentration calculation unit 320 to another apparatus. Further, output unit 330 may print the concentration information indicating the concentration calculated by concentration calculation unit 320.

Warning unit 340 compares the concentration calculated by concentration calculation unit 320 with a threshold value set in advance. When, as a result of this comparison, the concentration calculated by concentration calculation unit 320 exceeds the threshold value, warning unit 340 outputs a predetermined warning. At this time, warning unit 340 outputs a signal for performing processing for reducing the concentration. This warning may be one that displays a process for reducing the concentration at the same time as a predetermined alert output from information processing device 300. A process for reducing the concentration will be described later.

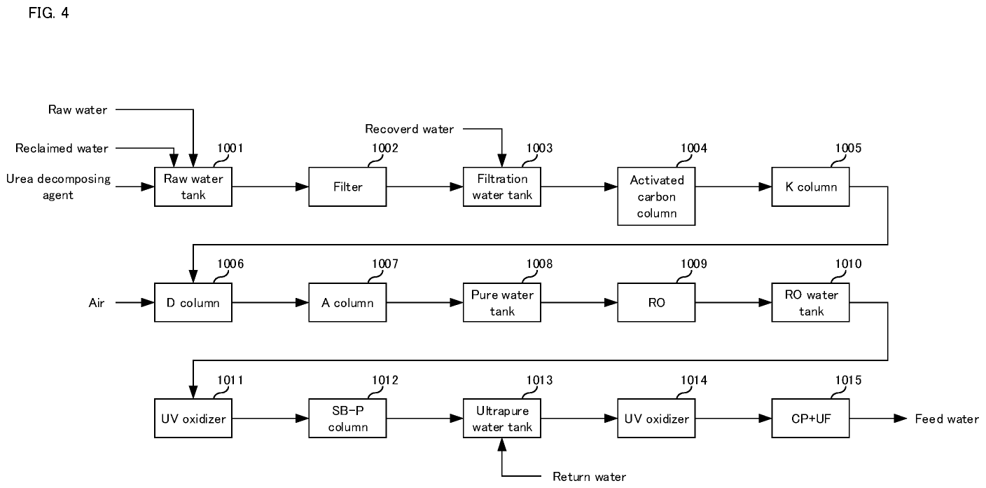

FIG. 4 is a diagram showing an example of a specific configuration of a water treatment system in the present embodiment. In the water treatment system shown in FIG. 4, the water treatment apparatuses or means for performing water treatment, which are raw water tank 1001, filter 1002, filtration water tank 1003, activated carbon column 1004, K column 1005, D column 1006, A column 1007, pure water tank 1008, RO device 1009, RO water tank 1010, UV oxidizer 1011, SB-P column 1012, ultrapure water tank 1013, UV oxidizer 1014, and CP+UF 1015 are connected in a series. Raw water and reclaimed water, which are water to be treated, are supplied to raw water tank 1001. Raw water tank 1001 is injected with a urea decomposing agent to remove urea in the water. Examples of the urea decomposing agent include hypohalous acid (e.g., hypobromous acid, hypochlorous acid, hypoiodous acid, and the like). Examples of the hypobromous acid include sodium hypobromite. Water flowing out of raw water tank 1001 is filtered by filter 1002. The filtered water is supplied to filtration water tank 1003. Recovered water is also supplied to filtration water tank 1003. Water flowing out of filtration water tank 1003 is supplied to activated carbon column 1004, which is a TOC removing device. The water treated in activated carbon column 1004 is supplied to K column 1005, which is a strong acid ion-exchange resin packed column. The water treated in K column 1005 is supplied to D column 1006, which is a decarboxylation column. Air is injected into the D column 1006 to remove carbon dioxide gas in the water. VOC (Volatile Organic Compounds) contained in this air adversely affect the removal of TOC in D column 1006. The water treated in D column 1006 is supplied to A column 1007, which is a strong basic anion-exchange resin packed column. The water treated in A column 1007 is stored as pure water in pure water tank 1008. Pure water stored in pure water tank 1008 is supplied to RO device 1009, which performs reverse osmosis membrane filtration. The membrane permeate water flow rate in RO device 1009 affects the removal of TOC in RO device 1009. The water treated by RO device 1009 is stored in RO water tank 1010. The water stored in RO water tank 1010 is supplied to UV oxidizer 1011, which is an ultraviolet (UV: UltraViolet) oxidizer, and is treated. The water treated by UV oxidizer 1011 is supplied to SB-P column 1012. The water treated in SB-P column 1012 is stored as ultrapure water in ultrapure water tank 1013. The ultrapure water stored in ultrapure water tank 1013 is supplied to UV oxidizer 1014, which is an ultraviolet oxidizer, and is treated. The water treated by UV oxidizer 1014 is supplied to CP+UF 1015, which is a non-regenerative ion exchanger (CP: Cartridge Polisher) and an ultrafiltration device (UF: UltraFiltration membrane), and is treated. From CP+UF 1015, treated water that has been treated is supplied externally as feed water from the system and used at the point of use. The feed water that is not used at the point of use is supplied as the return water to ultrapure water tank 1013.

In the configuration shown in FIG. 4, the processing for reducing the concentration supplied by warning unit 340 includes the following processes. Here, the series is an operation series provided in water treatment apparatuses 100-1 to 100-5 for removing impurities. For example, a plurality of series are provided in parallel in water treatment apparatuses 100-1 to 100-5. The plurality of series are provided to allow switching of the series used in operation.
Recycled water is not received in raw water tank 1001.
The injection amount of urea decomposing agent is increased to remove urea.
Recovered water is not received in filtration water tank 1003.
The series in activated carbon column 1004 is changed.
The series in K column 1005 is changed.
High-purity nitrogen is injected into D column 1006 instead of air.
The series in A column 1007 is changed.
The series in RO device 1009 is changed.
The flow rate of RO device 1009 is increased.
The number of lamps provided in UV oxidizer 1011 is increased.
The number of lamps provided in UV oxidizer 1014 is increased.

As described above, information processing device 300, based on the removal rates of each of water treatment apparatuses 100-1 to 100-5 calculated at a predetermined earlier time, calculates the concentration of impurities contained in the water to be supplied from the furthest downstream water treatment apparatus 100-5 in a case in which the currently supplied water is to be treated by water treatment apparatuses 100-1 to 100-5. Therefore, it is possible to comprehend in advance the water quality of the water to be supplied to the point of use.

### Second Embodiment

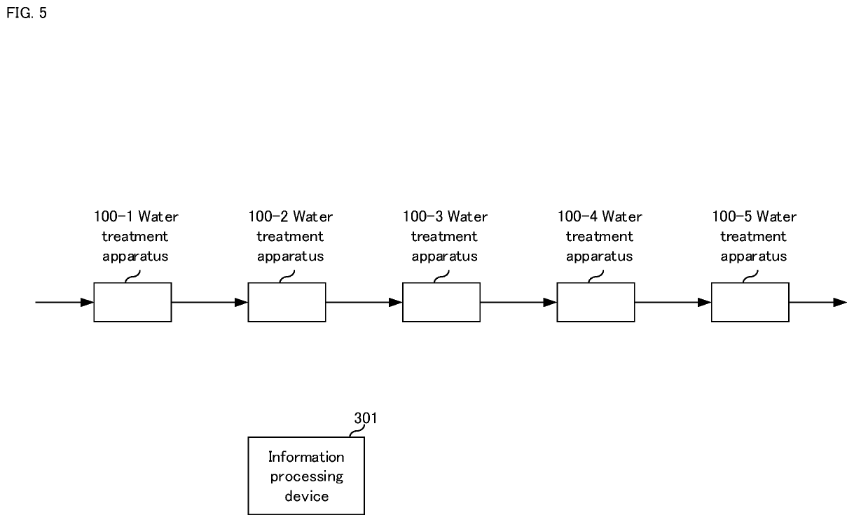

FIG. 5 is a diagram showing a second embodiment of the water treatment system of the present invention. As shown in FIG. 5, the water treatment system according to this embodiment includes a plurality of water treatment apparatuses 100-1 to 100-5 and information processing device 301.

Incidentally, in FIG. 5, the case of five water treatment apparatuses 100-1 to 100-5 is shown as an example. The number of water treatment apparatuses is not limited. Water treatment apparatuses 100-1 to 100-5 are the same as shown in FIG. 1.

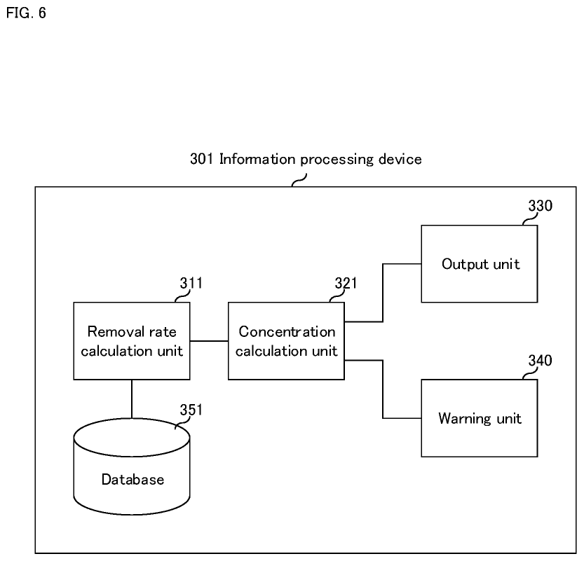

FIG. 6 is a diagram showing an example of the internal configuration of information processing device 301 shown in FIG. 5. As illustrated in FIG. 6, information processing device 301 illustrated in FIG. 5 includes a removal rate calculation unit 311, concentration calculation unit 321, output unit 330, warning unit 340, and database 351. Incidentally, of the components provided in information processing device 301 shown in FIG. 5, only the main components relating to the present embodiment are shown in FIG. 6. Output unit 330 and warning unit 340 are each the same as in the first embodiment.

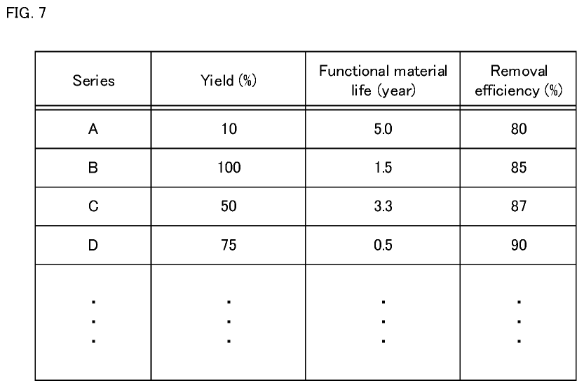

Database 351 stores past usage records. FIG. 7 is a table showing an example of information that shows the records of past use stored in database 351 shown in FIG. 6. In database 351 shown in FIG. 6, the series, yield, functional material life, and removal efficiency are stored in association as shown in FIG. 7. The series are as described above. Yield is the ratio of the amount of water sampled to a fixed quantity of the series. The units of yield are percent (%). In the case of a regenerative ion exchanger, according to the design of the device, the amount of sampled water for which the impurity removal function can be exhibited is a quantity. This quantity is called the fixed quantity. A regenerative ion exchanger in which the quantity of sampled water reaches the fixed quantity can recover the impurity removal function by going through a regenerative process. The life of functional material indicates the number of years the functional material is packed in that series. The removal efficiency is the efficiency of removing impurities in the series. The units of removal efficiency are percent (%). For example, as shown in FIG. 7, for series A, the yield “10,” the functional material life “5.0,” and the removal efficiency “80” are stored in association with each other. These records show that the removal efficiency was 80 (%) when 10 (%) of the fixed quantity of water flowed through series A after the passage of five years from packing the functional material. This shows that during the five years of being packed, the functional material has repeatedly undergone fixed quantity and regeneration for five years. As an example, the fixed quantity is generally 24 hours. Therefore, in five years, the fixed quantity and regeneration are repeated about 1800 times. The same applies to the functional material life described below. In addition, for series B, the yield “100,” the functional material life “1.5,” and the removal efficiency “85” are stored in association with each other. These records show that the removal efficiency was 85 (%) when 100 (%) of the fixed quantity of water flowed through series B after the passage of 1.5 years from packing the functional material. Also, for series C, the yield “50,” the functional material life “3.3,” and the removal efficiency “87” are stored in association with each other. These records show that the removal efficiency was 87 (%) when 50 (%) of the fixed quantity of water flowed through series C after the passage of 3.3 years from packing the functional material. In addition, for series D, the yield “75,” the functional material life “0.5,” and the removal efficiency “90” are stored in association with each other. These records show that the removal efficiency was 90 (%) when 75 (%) of the fixed quantity of water flowed through series D after the passage of 0.5 years from packing the functional material. Needless to say, the associations stored in database 351 are numerous and are not limited to these records. The number of associations stored in database 351 is preferably as great as possible. For example, it is preferable to store all of the past records of use for series A to D so that similar associations can be found with the state of use of series A to D currently being used in water treatment apparatuses 100-1 to 100-5.

Removal rate calculation unit 311 calculates the removal rates in each of water treatment apparatuses 100-1 to 100-5 based on the current states of use and removal efficiencies of the series that constitute each of water treatment apparatuses 100-1 to 100-5. The removal efficiency used here is the ability to remove impurities obtained from the records stored in database 351 of past use of the series constituting each of water treatment apparatuses 100-1 to 100-5. The impurity is, for example, organic carbon. For example, when water treatment apparatus 100-1 is composed of series A to D, and for series A, the current yield is 10 (%) and the packed functional material has been in use for 5 years, for series B the current yield is 100 (%) and the packed functional material has been in use for 1.5 years, for series C the current yield is 50 (%) and the packed functional material has been in use for 3.3 years, and for series D the current yield is 75 (%) and the packed functional material has been in use for 0.5 years, removal rate calculation unit 311 retrieves the data stored in database 351 that are similar (closest) to the state of each series. Removal rate calculation unit 311 acquires the removal rates (removal efficiency) associated with the retrieved data. Removal rate calculation unit 311 calculates the current removal rate of water treatment apparatus 100-1 using the obtained removal efficiency. For example, when the values shown in FIG. 7 are stored in database 351, removal rate calculation unit 311 may average the removal efficiency of each of series A to D. Alternatively, removal rate calculation unit 311 may calculate the overall removal rate using the configuration ratios of series A to D as weighting and multiplying each of the removal efficiencies. Thus, removal rate calculation unit 311 may calculate the average value of the removal efficiencies of the plurality of series used in one water treatment apparatus as the removal rate in that water treatment apparatus. Alternatively, removal rate calculation unit 311 may retrieve the closest data from the data obtained from the records of use of the series that is being used to calculate the current removal rate of the water treatment apparatus.

Concentration calculation unit 321 calculates the concentration of impurities contained in the water supplied from the water treatment apparatus disposed the farthest downstream of water treatment apparatuses 100-1 to 100-5 based on the removal rates of each of water treatment apparatuses 100-1 to 100-5 calculated by removal rate calculation unit 311. At this time, the concentration of impurities calculated by concentration calculation unit 321 is the concentration of impurities contained in the water supplied from the water treatment apparatus disposed the farthest downstream of water treatment apparatuses 100-1 to 100-5 when the currently supplied water is treated by water treatment apparatuses 100-1 to 100-5 in the connection configuration shown in FIG. 5, the water treatment apparatus disposed the farthest downstream being water treatment apparatus 100-5. Concentration calculation unit 321 calculates the concentration of impurities contained in the water supplied from the water treatment apparatus disposed the farthest downstream based on the concentration of impurities contained in the water flowing into the water treatment apparatus disposed the most upstream and the removal rates of water treatment apparatuses 100-1 to 100-5 calculated by removal rate calculation unit 311. For example, when the concentration of impurities contained in the water flowing into water treatment apparatus 100-1 disposed the most upstream is 1000 (ppb), the removal rate of water treatment apparatus 100-1 is 80%, the removal rate of water treatment apparatus 100-2 is 75%, the removal rate of water treatment apparatus 100-3 is 70%, the removal rate of water treatment apparatus 100-4 is 65%, and the removal rate of water treatment apparatus 100-5 is 60%:

1000×(1−0.8)×(1−0.75)×(1−0.7)×(1−0.65)×(1−0.6)=2 (ppb)

is the concentration of impurities contained in the water supplied from water treatment apparatus 100-5, which is disposed the farthest downstream. Incidentally, this numerical value is a value presented for convenience of explanation and is not intended as a value actually used in a normal system.

Thus, information processing device 301 calculates the removal rate in each of water treatment apparatuses 100-1 to 100-5 based on the current state of use of each of the series constituting water treatment apparatuses 100-1 to 100-5 and the removal efficiency, which is the ability to remove impurities obtained from the past records of use of each of the series constituting water treatment apparatuses 100-1 to 100-5. information processing device 301 then calculates the concentration of impurities contained in the water to be supplied from water treatment apparatus 100-5 disposed the farthest downstream based on the calculated removal rates of each of water treatment apparatuses 100-1 to 100-5. That is, information processing device 301 calculates the removal rate based on the current states of the series constituting water treatment apparatuses 100-1 to 100-5. Thus, the quality of the water supplied to the point of use can be comprehended in advance even when the processing in each of water treatment apparatuses 100-1 to 100-5 takes time.

Although described above by allocating each function (process) to a respective component, these assignments are not limited to those described above. In addition, as for the configuration of the components, the above-described embodiments are merely examples, and the present invention is not limited thereto. Further, the present invention may be a combination of the embodiments.

Further, information processing devices 300 and 301 may be provided in the cloud. In this case, the administrator who maintains, operates, and manages the system may access information processing devices 300 and 301 via the internet using a communication terminal and receive input and output of information.

The processing performed by each of the above-described information processing devices 300 and 301 may be performed by logic circuits manufactured according to the purpose. Further, a computer program (hereinafter, referred to as a “program”) in which the processing contents are described as procedures may be recorded on a recording medium that can be read by information processing devices 300 and 301, and the programs recorded on the recording medium may be read into and executed by information processing devices 300 and 301. The recording medium that can be read by information processing devices 300 and 301 may refer to a memory or an HDD (Hard Disc Drive) such as a ROM (Read Only Memory), a RAM (Random Access Memory), or the like incorporated in information processing devices 300 and 301, or may further refer to a transferable recording medium such as a floppy (registered trademark) disk, a magneto-optical disk, a DVD (Digital Versatile Disc), a CD (Compact Disc), a Blu-ray (registered trademark) Disc, and a USB (Universal Serial Bus) memory. The program recorded on the recording medium is read by a CPU provided in each of information processing devices 300 and 301, and the same processing as that described above is performed under the control of the CPU. Here, the CPU operates as a computer that executes a program read from a recording medium on which a program is recorded.

While the present invention has been described with reference to the embodiments, the present invention is not limited to the above embodiments. Various changes that will be understood by those skilled in the art within the scope of the present invention can be made in the configuration and details of the present invention.

This application claims priority based on JP 2020-151402 filed on Sep. 9, 2020 and incorporates all of its disclosure herein.

1. A water treatment system, comprising:
a water treatment apparatus that removes impurities from water that is supplied, and
an information processing device, wherein
the information processing device comprises:
a concentration calculation unit that, based on a removal rate for removing impurities in the water treatment apparatus, calculates a predicted value of a concentration of impurities contained in water to be supplied from the water treatment apparatus when water currently being supplied is treated by the water treatment apparatus.

2. The water treatment system according to claim 1, further comprising:
a removal rate calculation unit that calculates the removal rate, and
a storage unit that stores the removal rate of the water treatment apparatus that was calculated by the removal rate calculation unit, wherein
the concentration calculation unit calculates the predicted value of the concentration of impurities based on the removal rate stored in the storage unit.

3. The water treatment system according to claim 2, further comprising:
a concentration measuring unit that measures the concentration of impurities contained in water supplied to the water treatment apparatus and in water supplied from the water treatment apparatus, wherein
the removal rate calculation unit calculates the removal rate in the water treatment apparatus based on the concentration measured by the concentration measuring unit.

4. The water treatment system according to claim 3, wherein:
the concentration measuring unit measures the concentration of total organic carbon and the concentration of urea contained in water supplied from the water treatment apparatus, and
the removal rate calculation unit calculates the removal rate in the water treatment apparatus based on the concentration of the total organic carbon and the concentration of the urea measured by the concentration measuring unit.

5. The water treatment system according to claim 2, wherein:
the removal rate calculation unit calculates the current removal rate in the water treatment apparatus based on the current state of use and records of past use of the water treatment apparatus.

6. The water treatment system according to claim 1, wherein:
the information processing device includes an output unit that outputs information indicating a concentration calculated by the concentration calculation unit.

7. The water treatment system according to claim 1, wherein:
the information processing device includes a warning unit that outputs a predetermined alert when a concentration calculated by the concentration calculation unit exceeds a predetermined threshold value.

8. The water treatment system according to claim 7, wherein:
the warning unit outputs a signal for performing a process for reducing concentration when a concentration calculated by the concentration calculation unit exceeds a predetermined threshold value.

9. An information processing device, comprising:
a concentration calculation unit that, based on a removal rate for removing impurities in a water treatment apparatus that removes impurities from supplied water, calculates a predicted value of a concentration of impurities contained in water to be supplied from the water treatment apparatus when water currently being supplied is treated by the water treatment apparatus.

10. The information processing device according to claim 9, further comprising:
a removal rate calculation unit that calculates removal rate, and
a storage unit that stores the removal rate of the water treatment apparatus that was calculated by the removal rate calculation unit, wherein
the concentration calculation unit calculates the predicted value of the concentration of impurities based on the removal rates stored in the storage unit.

11. The information processing device according to claim 10, wherein
the removal rate calculation unit calculates the removal rate in the water treatment apparatus based on the concentration of impurities contained in the water supplied to the water treatment apparatus and the water supplied from the water treatment apparatus.

12. The information processing device according to claim 10, wherein
the removal rate calculation unit calculates the current removal rate in the water treatment apparatus based on the current state of use and records of past use of the water treatment apparatus.

13. An information processing method, comprising:
a process for, based on a removal rate for removing impurities in a water treatment apparatus that removes impurities from supplied water, calculating a predicted value of a concentration of impurities contained in water to be supplied from the water treatment apparatus when water currently being supplied is treated by the water treatment apparatus.

14. The information processing method according to claim 13, further comprising:
a process for calculating the removal rate,
a process for storing the calculated removal rate of the water treatment apparatus in a storage unit, and
a process for calculating the predicted value of the concentration of impurities based on the removal rates stored in the storage unit.

15. The information processing method according to claim 13, further comprising:
a process for measuring the concentrations of impurities contained in water supplied to the water treatment apparatus and in water supplied from the water treatment apparatus, and
a process for calculating the removal rate in the water treatment apparatus based on the measured concentrations.

16. The information processing method according to claim 13, further comprising:
a process for calculating the removal rate in the water treatment apparatus based on the current state of use and records of past use of the water treatment apparatus.

17. A program to make a computer execute procedures, the procedures comprising:
a procedure, based on a removal rate for removing impurities in a water treatment apparatus that removes impurities from supplied water, for calculating a predicted value of a concentration of impurities contained in water to be supplied from the water treatment apparatus when water currently being supplied is treated by the water treatment apparatus.

18. The program according to claim 17, the procedures further comprising:
a procedure for calculating the removal rate,
a procedure for storing the calculated removal rate of the water treatment apparatus in a storage unit, and
a procedure for calculating the predicted value of the concentration of impurities based on the removal rates stored in the storage unit.

19. The program according to claim 17, the procedures further comprising:
a procedure for measuring the concentrations of impurities contained in water supplied to the water treatment apparatus and in water supplied from the water treatment apparatus, and
a procedure for calculating the removal rate in the water treatment apparatus based on the measured concentrations.

20. The program according to claim 17, the procedures further comprising:
a procedure for calculating the removal rate in the water treatment apparatus based on the current state of use and records of past use of the water treatment apparatus.
